(19) United States
(12) Patent Application Publication
(10) Pub. No.: US 2014/0053373 A1
(43) Pub. Date: Feb. 27, 2014

(54) BUTTONS

(71) Applicant: Yuriy Zakuskin, Orekhov (UA)

(72) Inventor: Yuriy Zakuskin, Orekhov (UA)

(21) Appl. No.: 13/591,153

(22) Filed: Aug. 21, 2012

(51) Int. Cl. A44B 17/00; H01F 7/02; A44B 1/18

(52) U.S. Cl. 24/303; 24/594.11; 24/688

(57) ABSTRACT

Buttons are disclosed. The buttons can have a female portion and a male portion. The female portion can include a member configured to engage and retain the male portion. The female portion can include one or more of an annular elastic portion, a movable member with a magnet and a spring.

### FIELD

Embodiments relate generally to fasteners, and more particularly, to buttons having a stud and eyelet configuration.

### SUMMARY

Embodiments can include a button comprising a female portion. The female portion can have an annular elastic portion, a split ring, and a first casing configured to retain the annular elastic portion and the split ring. The button can also include a male portion. The male portion can have a stud having a shaft and a distal end, wherein the distal end has a diameter greater than a diameter of the shaft, and a second casing configured to retain the stud.

The annular elastic portion and the split ring can be configured to resist insertion of the distal end of the stud through a hole in the annular elastic portion and the split ring, and wherein when the distal end of the stud has been inserted through the hole, the annular elastic portion provides a force urging against the shaft portion to retain the male portion in an inserted position in the female portion.

The annular elastic portion can include a first part and a second part, each formed in a generally semicircular configuration in both plan and cross section. The first casing can include two parts adapted to be crimped together so as to retain the casing on a material, and wherein the second casing includes two parts adapted to be crimped together so as to retain the casing on a material. The first casing and the second casing can be made of metal. The annular elastic portion can be formed of a polymer and/or rubber.

One or more embodiments can include a button comprising a female portion. The female portion can have an annular movable portion having a magnet disposed on one side, and a first casing configured to retain the annular movable portion. The button can also include a male portion. The male portion can have a stud having a shaft and a distal end, wherein the distal end has a diameter greater than a diameter of the shaft, and a second casing configured to retain the stud.

The annular movable portion can be configured to engage the male portion and urged to retain the male portion in the female portion by force of the magnet against the shaft of the stud.

The first casing can include two parts adapted to be crimped together so as to retain the casing on a material, and wherein the second casing includes two parts adapted to be crimped together so as to retain the casing on a material. The first casing and the second casing can be formed from metal.

One or more embodiments can include a button comprising a female portion. The female portion can have a spring, and a first casing configured to retain the spring. The button can also include a male portion. The male portion can have a stud having a shaft and a distal end, wherein the distal end has a diameter greater than a diameter of the shaft, and a second casing configured to retain the stud.

The spring can be configured to engage the male portion and is urged to retain the male portion in the female portion by force of the spring. The first casing can include two parts adapted to be crimped together so as to retain the casing on a material, and wherein the second casing includes two parts adapted to be crimped together so as to retain the casing on a material. The first casing and the second casing can be formed from metal.

### BRIEF DESCRIPTION OF THE DRAWINGS

FIGS. 1-2 show diagrams of an example fastener (or button) having a split ring and annular elastic member in accordance with at least one embodiment.

FIG. 3 shows a diagram of an example press for forming component of a fastener or button in accordance with at least one embodiment.

FIG. 4 shows a diagram of an example button in accordance with at least one embodiment.

FIG. 5 shows a diagram of an example male member (or portion) being secured to fabric (or other) material in accordance with at least one embodiment.

FIG. 6 shows a diagram of an example button having a spring member in accordance with at least one embodiment.

FIGS. 7-8 show diagrams of an example button having an annular elastic member in accordance with at least one embodiment.

FIGS. 9-10 show diagrams of an example button having a magnetic member in accordance with at least one embodiment.

FIG. 11 shows a diagram of an example button having a spring member in accordance with at least one embodiment.

### DETAILED DESCRIPTION

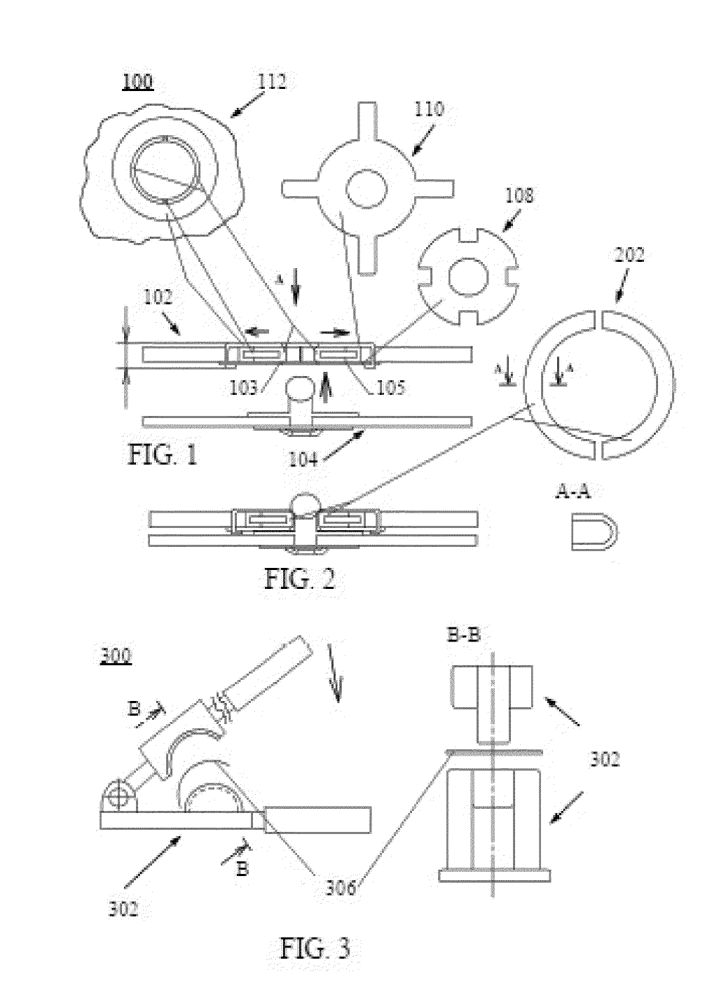

FIGS. 1-2 show diagrams of an example button (or fastener) system 100 having a split ring 103 and an annular elastic member (105/202) in accordance with at least one embodiment. The button 100 includes a female portion 102 and a male portion 104. The female portion includes a first casing (110 and 108) configured to retain the female portion 102.

The male portion 104 includes a stud having a distal end with a larger diameter than a shaft portion of the stud. The annular elastic assembly 112 (annular elastic portion 103 and the split ring 105) are configured to resist insertion of the distal end of the stud through a hole in the annular elastic portion and the split ring. When the distal end of the stud has been inserted through the hole, the annular elastic portion provides a force urging against the shaft portion to retain the male portion 104 in an inserted position in the female portion 102.

The annular elastic portion can be formed from rubber, synthetic material or a combination of the above. In general, any material with the suitable physical properties (e.g., elasticity, durability, and the like), can be used.

The annular elastic portion 202 can be formed in a generally semi-circular cross sectional shape so as to retain the split ring (see, FIG. 2, cross section A-A).

FIG. 3 shows a diagram of an example press 300 for forming a component of a fastener or button. The press can include a die 302 for forming components (e.g., metal pieces) 306.

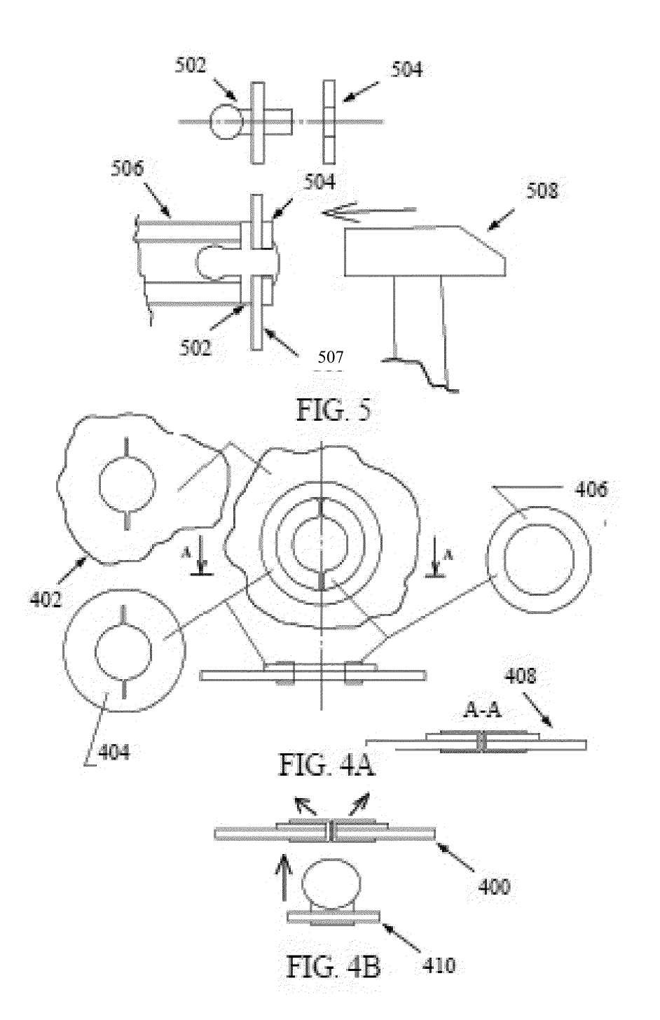

FIGS. 4A and 4B show diagrams of an example button attached to material 402. The button includes an elastic annular member 404 and a retaining ring 406. A cross section along line A-A is shown in 408.

The button can include a female portion 400 and a male portion 410, and can operate similar to the button 100 described above.

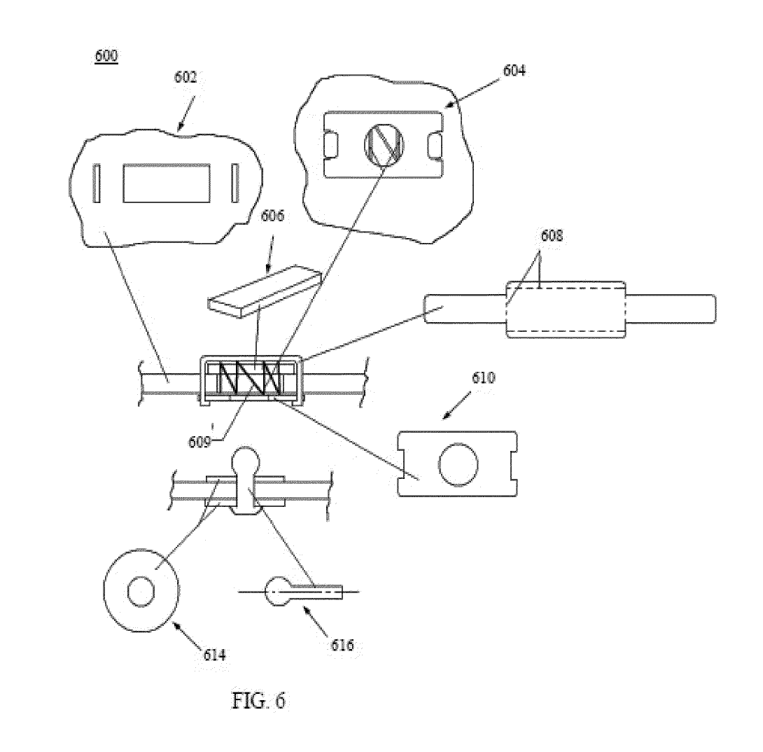

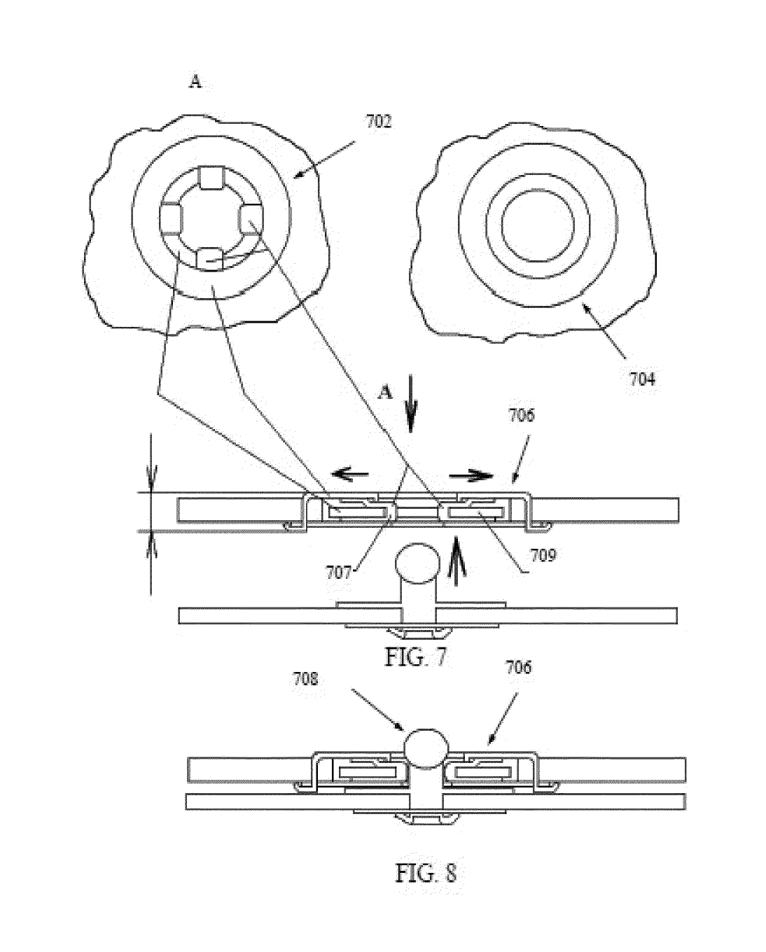

FIG. 5 shows a diagram of an example male member (or portion) being secured to fabric (or other) material in accordance with at least one embodiment. The male member includes a stud portion 502 and a grommet portion 504. To secure (or attach) the male member to material, the stud portion 502 is inserted into a die 506. The material 507 is placed over the stud portion (and may have an opening cut out to expose the stud back). The grommet 504 is placed over the material 507 substantially in alignment with the stud 502 and then the grommet 504 and the stud are clenched together via force of a tool 508.

FIG. 6 shows a diagram of an example button 600 having a spring member. The button 600 is attached to a fabric (or material) portion 602 and includes a female portion having an underside 604, an inner member 606, a top casing 608, a bottom casing 610. A male portion includes a stud portion 616 having a distal end with a diameter larger than a shaft portion and a plurality of retaining rings (or grommets) 614.

When the stud portion 616 is inserted into the female portion, the spring member 609 acts to resist and engage the stud portion 616.

FIGS. 7-8 show diagrams of an example button having an annular elastic member in accordance with at least one embodiment. The button includes a female portion 706 having an annular elastic assembly 702 having an annular elastic member 704 retained by casings 707.

A male portion 708 can be inserted into an annular opening disposed generally in the middle of the female portion 706 and can be retained by the elastic member 704.

FIG. 8 shows the button with the male portion 708 inserted into the female portion 706.

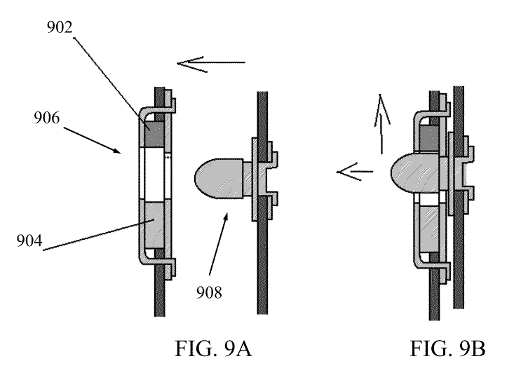

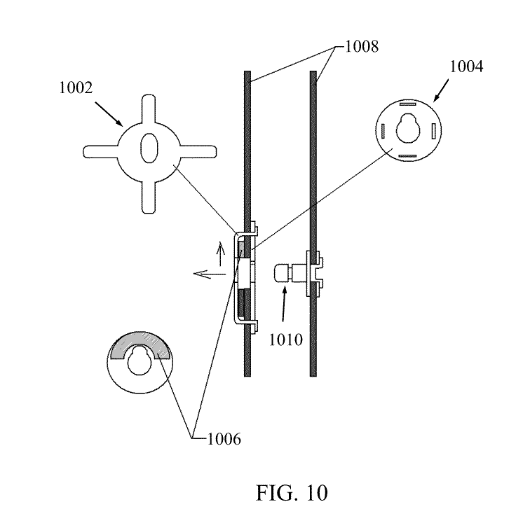

FIGS. 9A, 9B and 10 show diagrams of an example button having a magnetic member. The magnetic button includes a female portion 906 having a magnetic member 902 and a movable member 904. The magnetic member 902 and the movable member 904 are configured to engage a male portion 908 so as to releasably retain the male portion 908 in the female portion 906 by force of the magnetic member 902 urging the movable member 904 against a stud of the male member 908.

As shown in FIG. 10, the magnetic button can be attached to fabric (or material such as canvas, leather or the like) 1008. The magnetic button can include a female portion having a casing having a first portion 1002 and a second portion 1004 that are configured to be clenched together to secure the female portion to the material 1008. The casing retains the magnetic member/movable portion 1006.

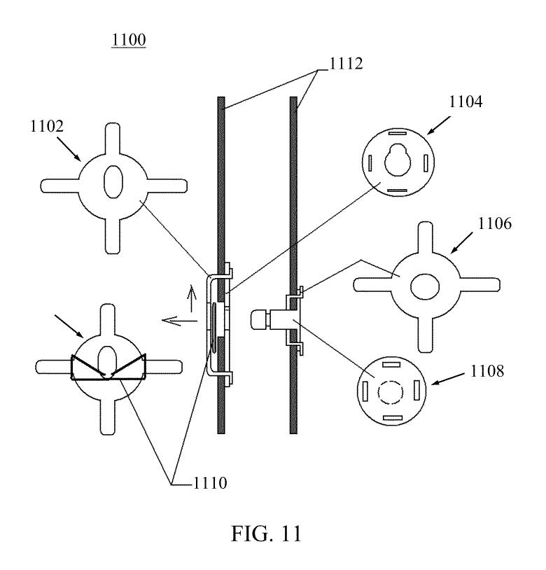

FIG. 11 shows a diagram of an example button 1100 having a spring member. The button 110 is configured with a female portion and a male portion adapted to be attached to material 1112. The female portion includes a casing with a first portion 1102 and a second portion 1104. The female portion also includes a spring member 1110. The male portion includes a casing with a first portion 1106 and a second portion 1108 configured to retain a stud.

The spring 1110 is configured to engage the male portion and is urged to retain the male portion in the female portion by force of the spring.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A button comprising:
a female portion having:
an annular elastic portion,
a split ring, and
a first casing configured to retain the annular elastic portion and the split ring; and
a male portion having:
a stud having a shaft and a distal end, wherein the distal end has a diameter greater than a diameter of the shaft, and
a second casing configured to retain the stud,
wherein the annular elastic portion and the split ring are configured to resist insertion of the distal end of the stud through a hole in the annular elastic portion and the split ring, and wherein when the distal end of the stud has been inserted through the hole, the annular elastic portion provides a force urging against the shaft portion to retain the male portion in an inserted position in the female portion.

2. The button of claim 1, wherein the annular elastic portion includes a first part and a second part, each formed in a generally semicircular configuration in both plan and cross section.

3. The button of claim 1, wherein the first casing includes two parts adapted to be crimped together so as to retain the casing on a material, and wherein the second casing includes two parts adapted to be crimped together so as to retain the casing on a material.

4. The button of claim 3, wherein the first casing and the second casing are metal.

5. The button of claim 1, wherein the annular elastic portion includes one or more of a polymer and rubber.

6. A button comprising:
a female portion having:
an annular movable portion having a magnet disposed on one side, and
a first casing configured to retain the annular movable portion; and
a male portion having:
a stud having a shaft and a distal end, wherein the distal end has a diameter greater than a diameter of the shaft, and
a second casing configured to retain the stud,
wherein the annular movable portion is configured to engage the male portion and is urged to retain the male portion in the female portion by force of the magnet against the shaft of the stud.

7. The button of claim 6, wherein the first casing includes two parts adapted to be crimped together so as to retain the casing on a material, and wherein the second casing includes two parts adapted to be crimped together so as to retain the casing on a material.

8. The button of claim 7, wherein the first casing and the second casing are metal.

9. A button comprising:
a female portion having:
a spring, and
a first casing configured to retain the spring; and
a male portion having:
a stud having a shaft and a distal end, wherein the distal end has a diameter greater than a diameter of the shaft, and
a second casing configured to retain the stud,
wherein the spring is configured to engage the male portion and is urged to retain the male portion in the female portion by force of the spring.

10. The button of claim 9, wherein the first casing includes two parts adapted to be crimped together so as to retain the casing on a material, and wherein the second casing includes two parts adapted to be crimped together so as to retain the casing on a material.

11. The button of claim 10, wherein the first casing and the second casing are metal.
